(19) United States
(12) Patent Application Publication
(10) Pub. No.: US 2003/0185143 A1
(43) Pub. Date: Oct. 2, 2003

(54) Multi-layer rewriteable information storage medium

(75) Inventors: Chih-Ming Lin, Taichung (TW); Wen-Yih Liao, Taichung (TW); Tzuan-Ren Jeng, Hsinchu (TW); Wen-Hsin Yen, Kaohsiung (TW); Huei-Wen Yang, Jungli City (TW)

Correspondence Address: BACON & THOMAS, PLLC, 625 SLATERS LANE, FOURTH FLOOR, ALEXANDRIA, VA, 22314

(73) Assignee: Industrial Technology research Institute, Hsin-Chu Hsien (TW)

(21) Appl. No.: 10/162,926

(22) Filed: Jun. 6, 2002

(30) Foreign Application Priority Data
Apr. 2, 2002 (TW) 091106556

(51) Int. Cl. G11B 7/007; G11B 7/24; G11B 3/70; B32B 3/02

(52) U.S. Cl. 369/275.4; 369/286; 428/64.3; 430/270.11; 430/270.13

(57) ABSTRACT

A multi-layer rewriteable information storage medium includes a substrate which is laminated with a plurality of information recording stacks to form a single side double information recording layers and double sides four information recording layers or more to greatly increase storage capacity. When reading or writing signals, laser beams of the optical pick-up head pass through replicated groove/land surfaces for tracking use to reach the information recording stacks. Hence tracking signals do not weaken when the thickness of the information recording stacks changes, and groove/land dimensions also may be maintained unchanged when the thickness of the information recording stacks changes. The laser beams can penetrate the substrate of a thickness from 0.1 mm to 1.2 mm to reach the information recording stacks. The storage medium of the invention can be used on existing optical disk drivers for reading or writing operations without a lot of structural changes.

### FIELD OF THE INVENTION

The present invention relates to a multi-layer rewriteable information storage medium adopted for use on optical disks with a single side double information recording layers and double sides four information recording layers or more.

### BACKGROUND OF THE INVENTION

In the era flooded with information and multimedia as we are living today, demands for greater medium density and capacity grow constantly. There are great requirements for data storage to provide higher quality animation, images, sound and greater capacity. DVD was developed and introduced to meet these needs. DVD is a breakthrough storage product that surpasses the capacity limit of 650 MB of a conventional CD, and increases recording capacity four to seven times, and offers improved recording quality and performance. In general, rewriteable optical storage media can be grouped to phase change type and magneto-optical type. The phase change type optical storage media only needs a single optical pick up head to record the signals on recording layers without an external magnetic field, and can read signals directly from variations of reflectance, so it is much simpler than the magneto-optical storage media. There are many different techniques now available for phase change optical storage media. They offer different densities or capacities (as shown in FIG. 1).

A Matsushita thesis (ISOM2000, We-C-01) discloses a technique shown in FIG. 2. It has a first information recording stack 2a formed on a first replicated groove/land surface 7a of a first substrate 1a and a second information recording stack 2b formed on a second replicated groove/land surface 7b of a second substrate 1b, in which the replicated groove/land surface is used for the tracking of the reaction light. The first substrate 1a and the second substrate 1b have the same thickness of 0.58 mm. Then the groove/land surfaces of the first substrate 1a and the second substrate 1b are faced toward each other and bonded to form a single side double information recording layers rewriteable optical disk. Laser beam is projected onto the smooth surface of the first substrate 1a. However, when reading or writing data on the second information recording stack 2b, the reaction light does not pass through the second replicated groove/land surface 7b located between the second information recording stack 2b and the second substrate 1b. This is due to the second information recording stack 2b is totally reflective, and when the thickness of the second information recording stack 2b increases, the original condition of the groove/land surface on the second substrate 1b cannot be clearly presented to every interlayer interface of the second information recording stack 2b. As a result, it is difficult to obtain desirable tracking signals from the second information recording stack 2b. To overcome this problem, an expensive stamper has to be made to modify groove/land dimensions of the second replicated groove/land surface 7b to compensate the weakening of tracking signals resulting from the increased thickness of the second information recording stack 2b. But the single side double information recording layers optical disk already has a thickness of 1.2 mm (the most widely used thickness for optical disks), this technique cannot be adopted for a single side triple information recording layers or double sides four information recording layers optical disks.

FIG. 3 illustrates a prior patent (EP1028421) which includes a second substrate 1b with a second replicated groove/land surface 7b formed thereon which is plated in advance with a reflective layer 4, then a second information recording stack 2b is plated thereon. Thereafter, a transparent layer 5 is plated on the second information recording stack 2b and a form of a first replicated groove/land surface 7a is made on the transparent layer 5 for laser tracking use, then a first information recording stack 2a is plated thereon. Finally a transparent protection layer 6 is coated on the first information recording stack 2a. Laser beams are projected through a surface end of the protection layer 6. Such a technique has the following disadvantages:

1. The laser beams cannot penetrate the reflective layer 4, therefore cannot reach the second replicated groove/land surface 7b located between the reflective layer 4 and the second substrate 1b. As a result, tracking signals of the second information recording stack 2b weaken when the thickness of the reflective layer 4 and the second information recording stack 2b increases. To overcome this problem, an expensive stamper has to be made to modify groove/land dimensions of the second replicated groove/land surface 7b to compensate the weakening of tracking signals resulting from the increased thickness of the reflective layer 4 and the second information recording stack 2b.

2. As laser beams have to pass through the first information recording stack 2a before reaching the first replicated groove/land surface 7a on the transparent layer 5, when the thickness of the first information recording stack 2a increases, tracking signals of the first information recording stack 2a weaken. To overcome this problem, another expensive stamper has to be made to modify groove/land dimensions of the first replicated groove/land surface 7a on the transparent layer 5.

3. The laser beams have to penetrate the transparent protection layer 6 of a thickness of 10-177 μm to reach the information recording stack. This technique is not adaptable to general CD-RW or rewriteable DVD disk drivers.

There is another conventional technique disclosed in a SONY thesis (ODS 2001 MB3). It plates a second information recording stack 2b on a second replicated groove/land surface 7b for laser tracking use formed on a second substrate 1b of a thickness 1.1 mm, and plates a first information recording stack 2a on a first replicated groove/land surface 7a for laser tracking use formed on a cover layer of a thickness 87 μm. Finally the second substrate 1b of the thickness 1.1 mm and the cover layer of the thickness 87 μm are bonded with the groove/land surfaces facing to each other to form a multi-layer rewriteable information storage medium. However when light is projected to read or write data on the second information recording stack 2b on the second substrate 1b, light cannot reach the second replicated groove/land surface 7b of the second substrate 1b, tracking signals of the second information recording stack 2b weakens due to increasing thickness of the second information recording stack. Moreover, laser beam is projected through the cover layer of 87 μm thickness, therefore the technique is not adaptable to general CD-RW or rewriteable DVD disk drivers.

There is still another conventional technique (U.S. Pat. No. 5,708,653) which plates a rewriteable information recording layer on a substrate with a groove/land surface, then coats UV paste on the information recording layer, and forms a pit information surface on the UV paste by means of a stamper, finally coats a reflective layer on the pit surface to form a read-only information recording layer. Although it has two information recording layers, only one of them is the phase change rewriteable recording medium, another one is the read-only recording medium. Hence it has only one rewriteable information recording layer.

### SUMMARY OF THE INVENTION

Therefore the primary object of the invention is to provide a multi-layer rewriteable information storage medium that has a plurality of information recording layers laminating on a substrate to form an information storage medium with a single side double information recording layers and double sides four information recording layers or more to greatly increase recording capacity of the storage medium.

Another object of the invention is to provide a multi-layer rewriteable information storage medium with a plurality of information recording stacks that are rewriteable and offer excellent tracking signals. Laser beams emitting from the laser pick-up head passes through a replicated groove/land surface for laser tracking use made by a stamper before reaching the information recording stacks. Hence the tracking signals do not weaken as the thickness of the information recording stacks changes. And replicated groove/land dimensions may remain unchanged as the thickness of the information recording stacks changes. Thus there is no need to make the expensive stamper to change the replicated groove/land dimensions.

In order to achieve the foregoing objects, the multi-layer rewriteable information storage medium of the invention includes a first substrate which has a first replicated groove/land surface for laser tracking use, and on the first replicated groove/land surface are formed sequentially a first information recording stack, a first isolation layer, a second information recording stack, an UV curing resin and a blank substrate with two flat surfaces. There contact surface between the first isolation layer and the second information recording stack is a second replicated groove/land surface for laser tracking use made by a stamper. Laser beams emitting from the laser pick-up head passes through the first replicated groove/land surface before reaching the first information recording stack, then passes through the second replicated groove/land surface and reaches the second information recording stack. Therefore tracking signals of all information recording stacks do not weaken as the thickness of the information recording stacks changes. Replicated groove/land dimensions also may remain unchanged as the thickness of the information recording stacks changes. Moreover, the layers may be stacked and laminated to form an information storage medium with double sides four information recording layers and a single side triple information recording layers or more, and recording capacity can be greatly increased.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a table of various conventional methods for increasing recording density or capacity of optical storage mediums.

FIG. 2 is a schematic view of the structure of a conventional storage medium.

FIG. 3 is a schematic view of the structure of another conventional storage medium.

FIG. 4 is a schematic view of the structure of the invention.

FIG. 5 is a schematic view of the structure of a first information recording stack of the invention.

FIG. 6 is a schematic view of the structure of a second information recording stack of the invention.

FIGS. 7A through 7E are schematic views of manufacturing processes according to the invention.

FIG. 8 is a schematic view of the structure of a single side triple information recording layers of the invention.

FIG. 9 is a table for optical characteristics of various information recording stacks of the invention.

FIGS. 10A, 10B and 10C are schematic views of the structure of double sides four information recording layers of the invention.

FIG. 11 is a table of comparison of the invention with conventional techniques.

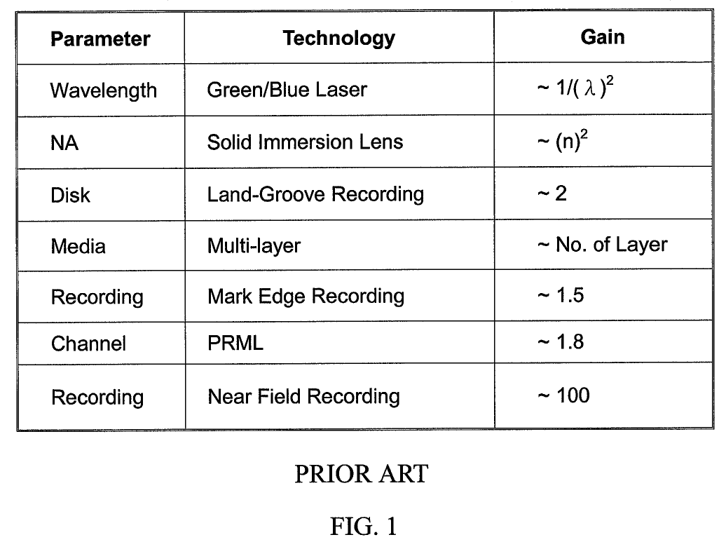

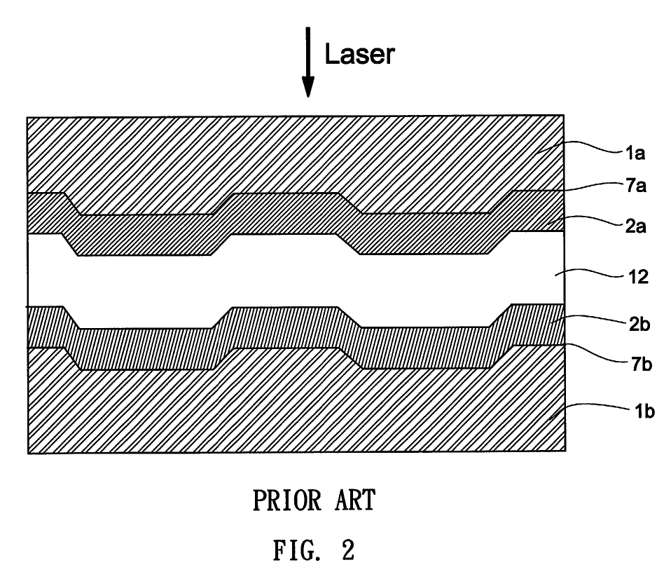

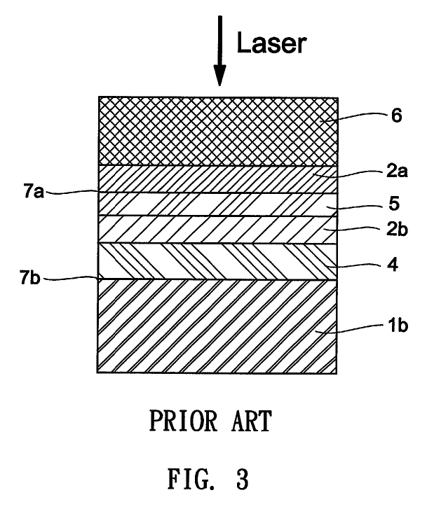

### DESCRIPTION OF THE PREFERRED EMBODIMENTS

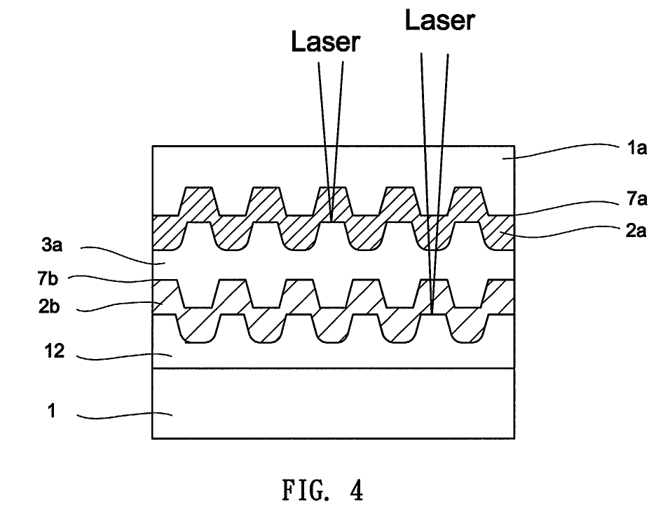

Referring to FIG. 4, the multi-layer rewriteable information storage medium of the invention includes a first substrate 1a which is laminated sequentially thereon a first information recording stack 2a, a first isolation layer 3a, a second information recording stack 2b, an UV curing resin 12 and a blank substrate 1 with two flat surfaces. The first substrate 1a has a first replicated groove/land surface 7a for laser tracking use formed thereon and may be made from polycarbonate, polymethyl methacrylate (PMMA) or polymer resin by injection forming or photo-polymerization with a thickness between 50 nm and 1.2 mm. The first replicated groove/land surface 7a is made by means of a stamper. The first information recording stack 2a is laminated on the first replicated groove/land surface 7a of the first substrate 1a. The first isolation layer 3a is laminated on the first information recording stack 2a and may be made from epoxy, acrylate or polyester. There is a second replicated groove/land surface 7b for laser tracking use formed by a stamper on another surface of the first isolation layer 3a. Then the second information recording stack 2b is formed on the second replicated groove/land surface 7b of the first isolation layer 3a. The UV curing resin 12 is coated on the second information recording stack 2b, then is bonded with the blank substrate 1 which has two flat surfaces to form a single side double recording layers rewriteable information storage medium.

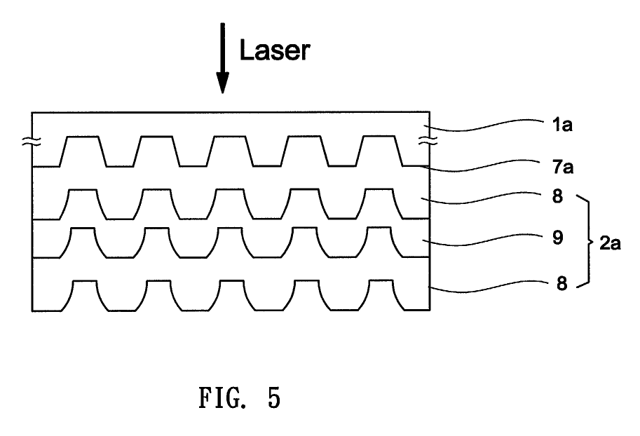

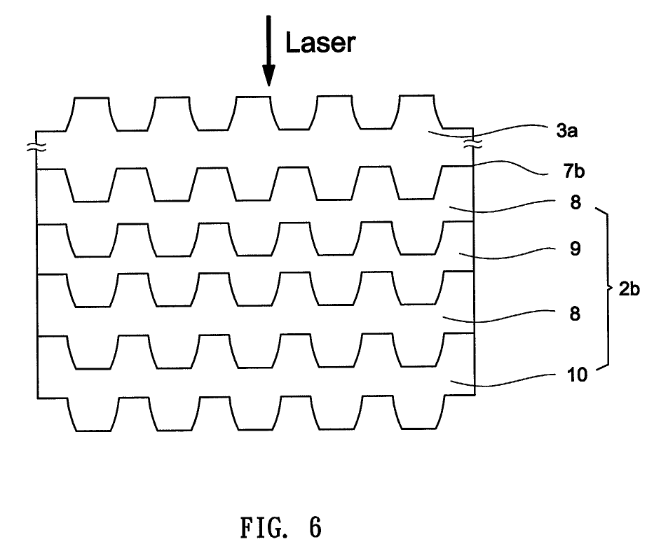

In addition, there is a recording layer 9 located in the first information recording stack 2a (as shown in FIG. 5) and in the second information recording stack 2b (as shown in FIG. 6) that is made from a phase change or magneto-optical material. In order to improve optical, thermal or magnetic properties of the information recording stacks, enhancement layers may be added around the recording layer 9, such as dielectric layers 8, a metal layer 10 or magnetic auxiliary layers or the likes. Refer to FIG. 5 for the layer construction of the first information recording stack 2a, light enters from the incident end and sequentially passes through the dielectric layer 8 of a thickness between 30 and 150 nm, the recording layer 9 of a thickness between 5 and 30 nm made from a phase change material and finally reaches another dielectric layer 8 of a thickness between 30 and 150 nm. Refer to FIG. 6 for the layer construction of the second information recording stack 2b. Light enters from the incident end and sequentially passes through the dielectric layer 8 of a thickness between 30 and 150 nm, the recording layer 9 of a thickness between 5 and 30 nm made from a phase change material, another dielectric layer 8 of a thickness between 30 and 150 μm, and finally reaches the metal layer 10 of a thickness between 30 and 200 nm.

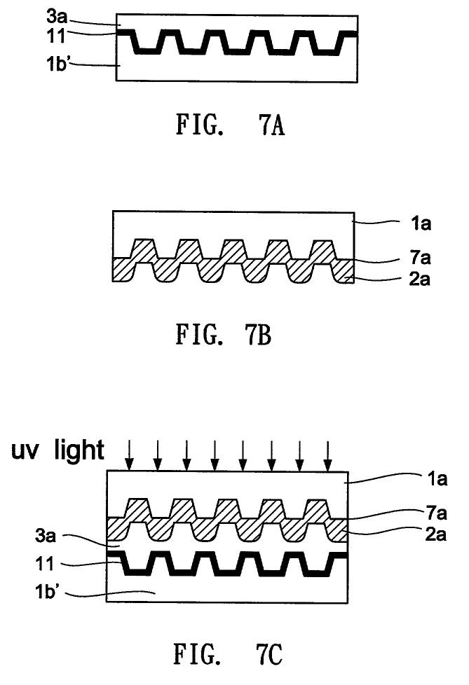

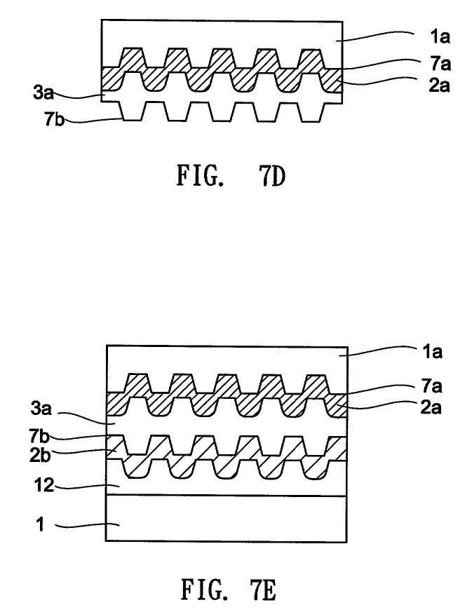

Refer to FIGS. 7A through 7E for manufacturing processes of the invention. First, as shown in FIG. 7A, form a groove/land shape metal surface 11 by sputtering Au, Ag, Al, Cr, Pt, Ni, Si or their alloys on a second substrate 1b′ (or through a stamper) which already has a groove/land shape surface formed thereon; the second substrate 1b′ may be made from polycarbonate, PMMA, glass or nickel at a thickness between 0.5 mm and 1.2 mm; then coat a polymer resin solution on the groove/land metal surface 11 of the second substrate 1b′ to form an uniform first isolation layer 3a (at a thickness between 20-75 μm); bond the first isolation layer 3a and a first information recording stack 2a plated on the first substrate 1a that already has the shape of the first replicated groove/land surface 7a (as shown in FIG. 7B); perform UV curing or heat baking (as shown in FIG. 7C); separate the first isolation layer 3a from the groove/land shape metal surface 11, and the first isolation layer 3a has a second replicated groove/land surface 7b formed thereon (as shown in FIG. 7D); then form sequentially on the second replicated groove/land surface 7b of the first isolation layer 3a a second information recording layer 2b, coat an UV curing resin 12, bond to a blank substrate 1 which has two flat surfaces to form a single side double recording layers rewriteable information storage medium (as shown in FIG. 7E). The overall structure and laser beam read/write conditions are shown in FIG. 4.

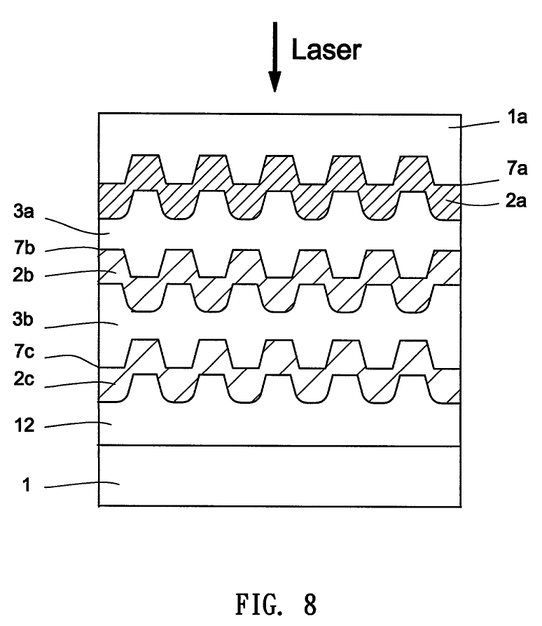

Repeat the method set forth above, but form a second isolation layer 3b made from polymer resin on the surface of the second information recording stack 2b with the shape of a third replicated groove/land surface 7c for laser tracking use, then plate a third information recording stack 2c on the third replicated groove/land surface 7c of the second isolation layer 3b to form a single side triple recording layers (as shown in FIG. 8) or a single side triple or more recording layers rewriteable information storage medium. When producing two or more information recording stacks, the most remote information recording stack is a totally reflective type, and the rest information recording stacks are semi-transparent type.

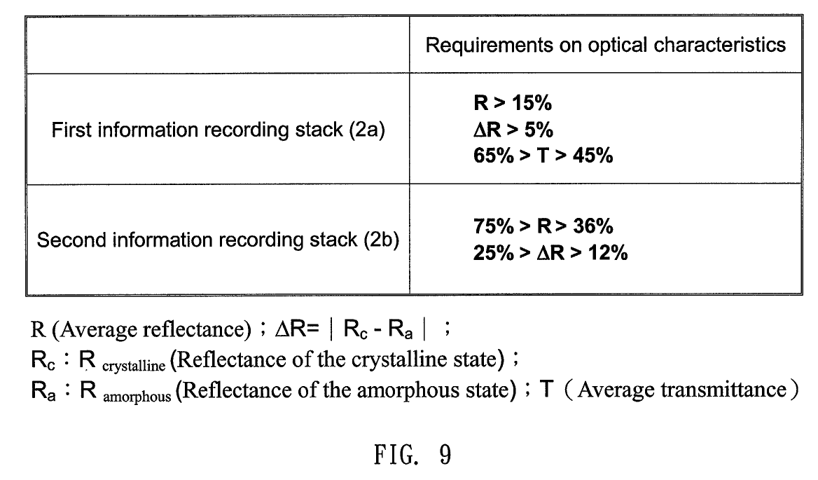

On the rewriteable information storage medium having a single side double recording layers, optical properties of various information recording stacks (such as the first information recording stack 2a and the second information recording stack 2b) must enable the reflective light signal intensity proximate to one another when laser beams are projected to read the various information recording stacks. And in order to make the reflective light intensity of the laser beams projecting on the first information recording stack 2a and the second information recording stack 2b reaching a degree acceptable to general CD-RW or rewriteable DVD optical disk drives, i.e. with reflectance over 15%, and the value of |Rc−Ra | more than 5% (where Rc is the reflectance of the crystalline state, and Ra is the reflectance of the amorphous state), optical characteristics of the first information recording stack 2a and the second information recording stack 2b have to meet certain requirements which are shown in FIG. 9, where R indicates average reflectance of various information recording stacks, T indicates average transmittance of various information recording stacks, and recording types of various information recording stacks may be any one of combinations which include crystalline-to-amorphous or amorphous-to-crystalline, and high-to-low or low-to-high reflections.

Based on aforesaid characteristics, preferred embodiments of the invention are discussed as follows with accompanying drawings:

Embodiment No. 1: Single Side Multiple Information Recording Layers

The multi-layer rewriteable information storage medium of a single side multiple information recording layers includes a first substrate 1a having a first replicated groove/land surface 7a, a plurality of information recording stacks, an UV-curing resin 12, and a blank substrate 1. An isolation layer with a replicated groove/land surface for laser tracking use is formed between the information recording stacks. The number of the information recording stacks is depended on the number of the information recording layers, such as three information recording stacks for three information recording layers.

Refer to FIG. 4 for the multi-layer rewriteable information storage medium of a single side double information recording layers. The structure includes a first substrate 1a having a first replicated groove/land surface 7a, and forms sequentially thereon a first information recording stack 2a, an isolation layer 3a with a second replicated groove/land surface 7b, a second information recording stack 2b, an UV-curing resin 12, and a blank substrate 1.

FIG. 8. Illustrates a multi-layer rewriteable information storage medium for a single side triple information recording layers. It includes a first substrate 1b with a first replicated groove/land surface 7a, and forms sequentially thereon a first information recording stack 2a, a first isolation layer 3a with a second replicated groove/land surface 7b, a second information recording stack 2b, a second isolation layer 3b with a third replicated groove/land surface 7c, a third information recording layer 2c, an UV-curing resin 12 and a blank substrate 1.

Embodiment No. 2: Double Sides Four Information Recording Layers

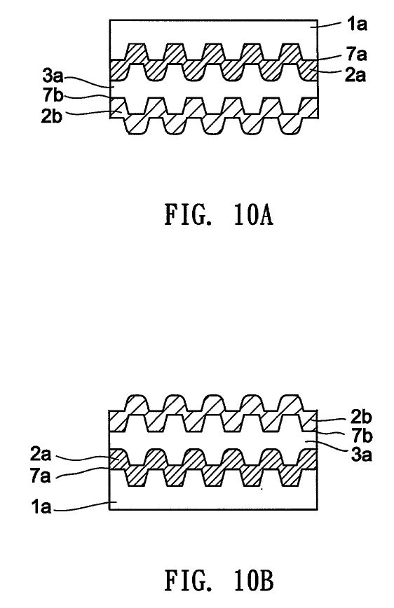

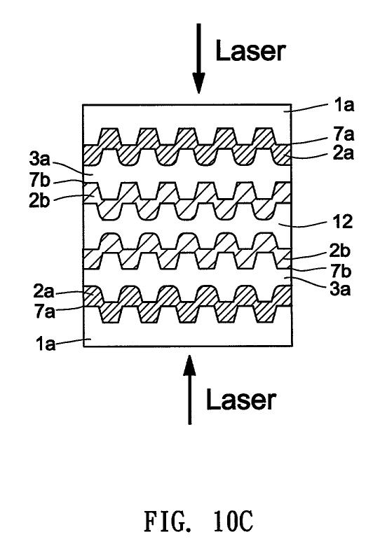

Referring to FIG. 10C, the structure of double sides four information recording layers may be formed by bonding an UV-curing resin 12 between a pair of single side double information recording layers structures (as shown in FIGS. 10A and 10B), with the first information recording stack 2a and the second information recording stack 2b being same as the ones discussed in the Embodiment No. 1. In addition, on the double sides four information recording layers structure, laser beams of the read/write head may be projected and entered from the upper and under sides.

Comparisons of the Invention with Conventional Techniques:

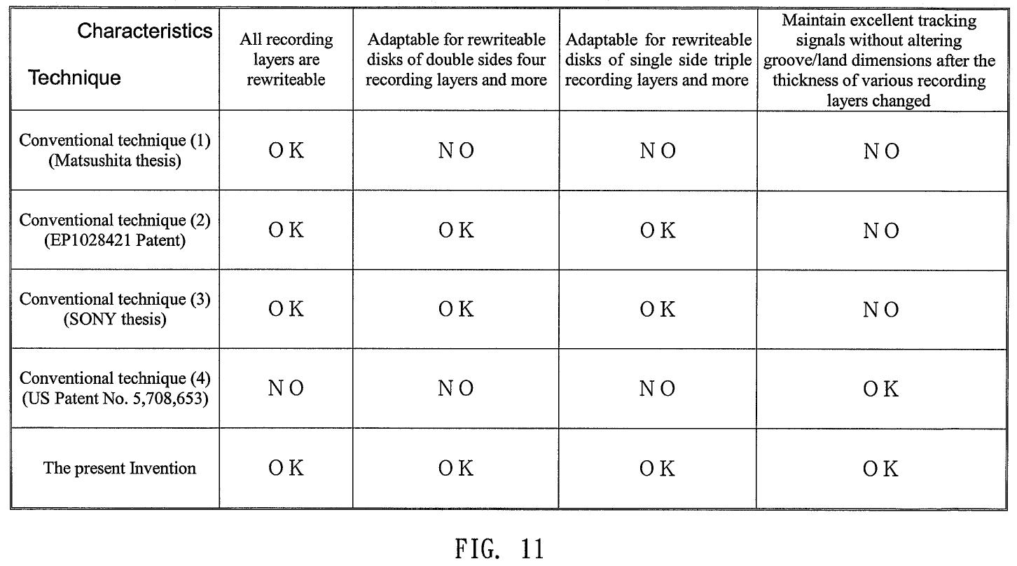

As shown in FIG. 11, advantages of the invention are obvious comparing with conventional techniques, notably:

1. All information recording stacks are rewriteable.

2. Adaptable for optical disks of double sides four information recording layers and more.

3. Adaptable for optical disks of single side triple information recording layers and more.

4. Excellent tracking signals can be provided without changing groove/land dimensions even the thickness of various information recording stacks is altered (this can save the cost of expensive stampers that might otherwise needed for changing groove/land dimensions resulting from altering of the thickness of the information recording stacks).

5. Laser beams can penetrate the substrate of thickness of 0.1 mm, 0.6 mm or 1.2 mm to reach the information recording stacks. Thus optical disks made according to the invention are acceptable and usable on optical disk drives of existing CD-RW or rewriteable DVD, or future DVR disks that adopt blue light laser without much structural modifications.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A multi-layer rewriteable information storage medium, comprising:
a first substrate having a first replicated groove/land surface for laser tracking use;
a first information recording stack being laminated on the first replicated groove/land surface of the first substrate;
a first isolation layer being laminated on the first information recording stack and having another surface formed a second replicated groove/land surface for laser tracking use;
a second information recording stack being laminated on the second replicated groove/land surface of the first isolation layer;
an UV curing resin coating on the second information recording stack; and
a blank substrate being laminated on the UV curing resin and having two flat surfaces.

2. The multi-layer rewriteable information storage medium of claim 1, wherein the first substrate is selectively made from polycarbonate, polymethyl methacrylate or polymer resin and the first replicated groove/land surface is made by injection forming or photo-polymerization through a stamper.

3. The multi-layer rewriteable information storage medium of claim 1, wherein the first substrate has a thickness ranging from 10 nm to 2 mm, and preferably ranging from 50 nm to 0.6 mm.

4 The multi-layer rewriteable information storage medium of claim 1, wherein the first information recording stack and the second information recording stack have respectively a recording layer which is selectively made from a phase change material or a magneto-optical material, and include enhancement layers which can improve the optical, thermal or magnetic characteristics thereof, the enhancement layers being selected from the group consisting of a dielectric layer, a metal layer or a magnetic auxiliary layer.

5 The multi-layer rewriteable information storage medium of claim 1, wherein the first isolation layer is made from a material selecting from the group consisting of epoxy, acrylate or polyester, and the second replicated groove/land surface is formed by photo-polymerization through a stamper.

6 The multi-layer rewriteable information storage medium of claim 1, wherein the first isolation layer has a thickness ranging from 0.1 μm to 100 μm, and preferably ranging from 20 μm to 75 μm.

7 The multi-layer rewriteable information storage medium of claim 1 further having a plurality of information recording stacks formed between the second information recording stack and the UV curing resin, and having isolation layers and replicated groove/land surfaces located between the information recording stacks to form a multi-layer rewriteable information storage medium of a single side triple or more information recording layers.

8 The multi-layer rewriteable information storage medium of claim 1, wherein the number of the information recording stack is determined by the number of information recording layers.

9 The multi-layer rewriteable information storage medium of claim 1, wherein the rewriteable information storage medium is a single side double or more information recording layers medium, the information recording stack most remote from a laser beam source being a totally reflective type and the rest information recording stacks being semi-transparent type.

10 The multi-layer rewriteable information storage medium of claim 1, wherein two sets of the rewriteable information storage medium of a single side information recording layer are laminated with another UV curing resin located therebetween to form a double sides multi-layer rewriteable information storage medium.

11 The multi-layer rewriteable information storage medium of claim 2, wherein the stamper is a substrate having a surface formed by a material selected from the group consisting of Au, Ag, Al, Cr, Pt, Ni, Si or their alloys with a groove/land shape for laser tracking use, the substrate being made from a material selected from the group consisting of polycarbonate, polymethyl methacrylate, glass or nickel.

12 The multi-layer rewriteable information storage medium of claim 11, wherein the Au, Ag, Al, Cr, Pt, Ni, Si or their alloys has a thickness ranging from 3 nm to 100 nm, and preferably ranging from 5 nm to 60 nm.

13 The multi-layer rewriteable information storage medium of claim 5, wherein the stamper is a substrate having a surface formed by a material selected from the group consisting of Au, Ag, Al, Cr, Pt, Ni, Si or their alloys with a groove/land shape for laser tracking use, the substrate being made from a material selected from the group consisting of polycarbonate, polymethyl methacrylate, glass or nickel.

14 The multi-layer rewriteable information storage medium of claim 13, wherein the Au, Ag, Al, Cr, Pt, Ni, Si or their alloys has a thickness ranging from 3 nm to 100 nm, and preferably ranging from 5 nm to 60 nm.
